(19) United States
(12) Patent Application Publication
(10) Pub. No.: US 2024/0189933 A1
(43) Pub. Date: Jun. 13, 2024

(54) DYNAMIC CONTROL SYSTEM FOR PROVIDING OPTIMAL GASEOUS FLUX IN MACHINING OF WORKPIECE MATERIAL AND RELATED CONTROL METHOD

(71) Applicant: Aurion Machining Technologies Oy, Helsinki (FI)

(72) Inventors: Kari Rinko, Helsinki (FI); Leo Hatjasalo, Helsinki (FI)

(21) Appl. No.: 18/538,306

(22) Filed: Dec. 13, 2023

Related U.S. Application Data
(60) Provisional application No. 63/432,098, filed on Dec. 13, 2022.

(51) Int. Cl. B23K 10/00; B23K 37/00

(52) U.S. Cl. CPC B23K 10/006; B23K 37/003

(57) ABSTRACT

A control system of gaseous flux for machining material of a workpiece in a machining area. The system comprises a module comprising an electric field chamber for producing and outputting ionized gaseous flux from input, preferably continuous, gaseous flow, and control and monitoring equipment at least functionally connected with the module. The control and monitoring equipment is configured to dynamically, optionally substantially continuously, estimate, measure and/or adjust, based on input sensing data, a number of flux characteristics including flow rate, polarity and/or ionization level, such as density of ionization, so as to provide and/or control, optionally stabilize, a number of reactions advantageously including electrochemical reactions in the machining area, optionally including neutralization of workpiece and machining tool electric charges, oxidation of workpiece or workpiece and tool interface, and/or reducing temperature at workpiece and tool surfaces and associated interface.

### CROSS REFERENCE TO RELATED APPLICATIONS

This application claims the benefit of U.S. Provisional Application No. 63/432,098 entitled “DYNAMIC CONTROL SYSTEM FOR PROVIDING OPTIMAL GASEOUS FLUX IN MACHINING OF WORKPIECE MATERIAL AND RELATED CONTROL METHOD” and filed on Dec. 13, 2022, which is incorporated herein by reference in its entirety.

### FIELD

The present invention relates generally to machining a workpiece. Especially, however not exclusively, the present invention relates to dynamic control of continuous gaseous flux for machining workpiece material without coolant fluid or generally, metalworking fluids.

### BACKGROUND

There are many recent challenges in metal cutting, arising e.g., from the increased use of special alloys with advanced properties, tightened quality requirements for machined parts, changing or unstable process conditions and output, cost and efficiency aspects, as well as environmental and ecological concerns. Thus, new solutions are desired for global metal cutting industry.

There are some solutions for liquid-free machining. One interesting and promising method is utilizing ionized air in metal cutting zone. This method and related considerations have been presented in a publication WO2022/148912A1, which is incorporated herein by reference in its entirety. However, there still remains room for a practical solution, which overcomes or at least alleviates one or more of the aforesaid challenges. Many of the ideas set forth in the field are based on laboratory set-ups and short-time trials only without industrial level applicability in terms of e.g., process efficiency and yield, with reference to e.g., uniformity and generally quality of machining result and the amount of tool wear among other factors. There are thereby no holistic commercial system solutions available, which could be utilized.

### SUMMARY OF THE INVENTION

An object of the invention is to alleviate at least some of the problems associated with the prior art. In one aspect, a control system of gaseous flux for machining material of a workpiece in a machining area e.g., on a machining table is provided, wherein the contacting materials of the workpiece and machining tool are preferably mutually different and electrically charging and/or electrically conductive such as metals or other materials of that nature, the system comprising:
a module comprising an electric field chamber for producing and outputting ionized gaseous flux from input, preferably continuous, gaseous flow; and
control and monitoring equipment at least functionally connected with the module, wherein the control and monitoring equipment is configured to dynamically, optionally substantially continuously, estimate, measure and/or adjust, based on input sensing data, a number of flux characteristics including flow rate, polarity and/or ionization level, such as density of ionization, so as to provide and/or control, optionally stabilize, a number of reactions advantageously including electrochemical reactions in the machining area, optionally including neutralization of workpiece and machining tool electric charges, oxidation of workpiece or workpiece and tool interface, and/or reducing temperature at workpiece and tool surfaces and associated interface.

The system may be configured to utilize data about optionally at least quasi-constant basic parameters or characteristics of a concerned use scenario, optionally indicated by the sensing data and/or including preset or user-selected data, in determining the (target for the) adjustment of the number of flux characteristics, wherein the parameters or characteristics comprise or are based on at least one element selected from the group consisting of: material of the machining tool (at the workpiece and tool interface), material of the workpiece, machining technology utilized, gas or gaseous fluid utilized, tool type and dimensions, and workpiece dimensions.

In some embodiments, the sensing data utilized in determining (the target for) the adjustment may indicate or may be processed or otherwise utilized to indicate current and/or past characteristics of the input gaseous flow, such as pressure, temperature or dew point, one or more of the characteristics of the output ionized gaseous flux, properties or conditions at the interface between the workpiece and the machining tool, property or condition of the machining tool such as dimensions and/or wear, and/or property or condition of the workpiece.

The adjustment may be based on a difference between a selected desired output ionized gaseous flux determined through utilization of the sensing data and optionally further data such as data indicative of preset or user-selected use scenario characteristics, and current output ionized gaseous flux optionally determined based on current control parameters of the system or one or more elements of the system (e.g. programmable module, control and monitoring equipment, etc.) and/or sensing data, further wherein the difference is to be minimized by the dynamic adjustment of the number of flux characteristics.

The system may comprise a filter or membrane dryer for the gaseous flow, such as compressed air flow, preferably positioned upstream from an optional cooling unit and/or downstream from an optional compressor, to achieve a low dew point for the gaseous flow, preferably lower than the (operating) temperature of gaseous flow.

The system may comprise a cooling unit for the gaseous flow, preferably positioned upstream from the module and/or downstream from the optional dryer, configured to produce temperature falling within a range between about +15° C. and about −30° C. for the gaseous flow.

The system may be configured to optimize, preferably minimize, gaseous flow rate, optionally at the module, cooling unit, and/or other element of the system, to spare energy and/or the gaseous fluid used for establishing the gaseous flow and subsequent ionized gaseous flux.

The system may comprise at least one element selected from the group consisting of:
power supply unit preferably with a number of AD conversion channels, positioned between the programmable module and control and monitoring equipment or at least partially integrated with either;
a number of wired and/or wireless communications links optionally in the form of a network or communication bus, between the control and monitoring equipment and the programmable module, other element of the system, and/or external monitoring or control system or device, wherein data transferred preferably include sensing data such as data indicative of machining force, temperature, tool wear and/or surface quality, said data optionally utilized for optimizing the flux characteristics during adjustment thereof, wherein the communication bus optionally comprises Meter-Bus; and
processing device such as a microprocessor, a digital signal processor, ASIC (application specific integrated circuit), or a microcontroller, for processing data such as instructions and other data such as sensing data, memory for storing data, and a communications adapter such as a wired or wireless network adapter or serial interface adapter for exchanging data.

The system may be configured to provide negative polarity, positive polarity, or bi-polarity in the electric field chamber to perform the adjustment.

The system may be configured to provide and adjust ion content, total charge, and/or polarity for the ionized gaseous flux.

The system may be configured to adjust flow rate per unit area preferably to reduce tool wear, acoustic emission noise and/or machining forces.

In one embodiment, pneumatic air flow control may be adjusted. This may be beneficial especially in a drilling process, wherein pulsed air flow supports material chips removal from the drilling hole.

One aspect of the invention relates to a method for controlling the provision of gaseous flux in machining workpiece material, wherein the workpiece and machining tool materials are preferably mutually different and electrically charging and/or conductive such as metals, comprising:
producing and outputting ionized gaseous flux based on, preferably continuous, gaseous flow of gaseous fluid through utilization of a programmable module comprising an electric field chamber,
   wherein a number of flux characteristics including flow rate, polarity and/or ionization level, such as density of ionization, are dynamically, optionally substantially continuously, measured, estimated and/or adjusted, based on input sensing data, so as to provide or control, optionally stabilize, a number of reactions advantageously including electrochemical reactions in the machining area whereto the flux is directed, optionally including neutralization of workpiece and machining tool electric charges, oxidation of workpiece or workpiece and tool interface, and/or reducing temperature at workpiece and tool surfaces and associated interface

Various embodiments of the present invention provide an essentially real-time dynamic, adaptive control over optimal gaseous flux for machining workpiece materials. Different process parameters may be measured, controlled (incl. stabilization) by specific control and monitoring equipment including both hardware and software. The software may be embodied on a carrier medium such as a non-transitory medium. The medium may include e.g., a memory card, optical disc or some other tangible medium. Yet, the software could be transferred as a signal (wired or wireless). The software may consist of or comprise a computer program (product) comprising instructions which, when the program is executed by a computer, will cause the computer to carry out various activities and e.g., method items/steps contemplated hereinafter.

The aforementioned process parameters may comprise e.g., a value of a control signal, such as pulse width (pulse ratio) of a modulation (PWM) signal, utilized in an element such as an electric field chamber to control, in turn, a number of associated features. The process parameters to be controlled may comprise, for example, loop current of corona, negative or positive polarity or bi-polarity (of electric field in the corona chamber), temperatures and dew point of gaseous flux, pressure including ion charge and content, etc. Yet, machining forces and temperatures, tool wear and/or surface quality, may be monitored and/or controlled, etc.

Having regard to further utilities of different embodiments of the present invention, the suggested solution advantageously generates a consistent and reliable process performance for coolant free machining, wherein gaseous flux is applied in adjusting, optionally specifically neutralizing, workpiece and tool electric charges and electrochemical reactions, oxidating workpiece or workpiece—tool interface (to lessen friction, protect the concerned surfaces, etc.), and/or reducing temperature in workpiece and tool surfaces and their interfaces.

By the embodiments of the present invention, continuous and active, dynamic control over various parameters and characteristics of the gaseous flux, such as polarity or temperature, is indeed achieved. The optimized, optimal gaseous flux process provides a consistent and reliable process performance for coolant free machining. For example, direction of electric current may be adjusted (through ionized gaseous flux with proper polarity dependent on e.g., the type of metals/conductive materials used as the workpiece or in the tool) at the machining tool—workpiece interface and related surfaces to reduce e.g., tool wear. Flow rate and/or ionization level may be increased to compensate for the wear, for instance. Basic output flux is or at least contains preferably dry and cool(ed) ionized gas such as air, which thus acts as a coolant and lubricant without metalworking fluids while yielding several desired electrochemical reactions and phenomenon in the machining zone (area). This flux may be delivered through or established by a number of different elements preferably incorporated in or at least controlled by the system described herein.

What comes the versatility of the embodiments of the present invention, the present invention is fully applicable for a plurality of different machining technologies, such as turning, milling and drilling, etc., and for different materials (workpiece 132, tool 114), such as carbon steel, stainless steel, aluminium, titanium, etc., as well as non-conductive materials such polymers, ceramic, etc. The present solution can also be applied to and integrated in both existing and new machining equipment and tools. Existing liquid channels can be utilized to channel the gaseous flux. Dynamic system is configured to adapt and optimize flux parameters, such as flow volume, polarity, ionization level, etc, for each currently utilized tool, wherein characteristics such as e.g., channel length and dimensions may vary.

The beneficial measured machining performances provided by various embodiments include effectiveness and productivity, surface quality, and tool life, which are generally at least on the same level, or in some instances even better, as with metalworking fluids. The additional benefit is that the machined pieces, as well as the chips, are free from residuals, which is fundamentally important, for example, in the medical industry. In the end there are more important features available, such as measurable health, environmental, sustainability and economic benefits (elimination of potentially hazardous coolants and fluids), which all serving the today's and future trends in the machining industry.

### BRIEF DESCRIPTION OF THE DRAWINGS

Next the invention will be described in greater detail with reference to exemplary embodiments in accordance with the accompanying drawings, in which:

FIG. 1 shows an exemplary system,

FIG. 2 illustrates a flow chart of an exemplary method, and

FIGS. 3 and 4 show measurement data relating to use of compressed air vs cooled air.

### DETAILED DESCRIPTION

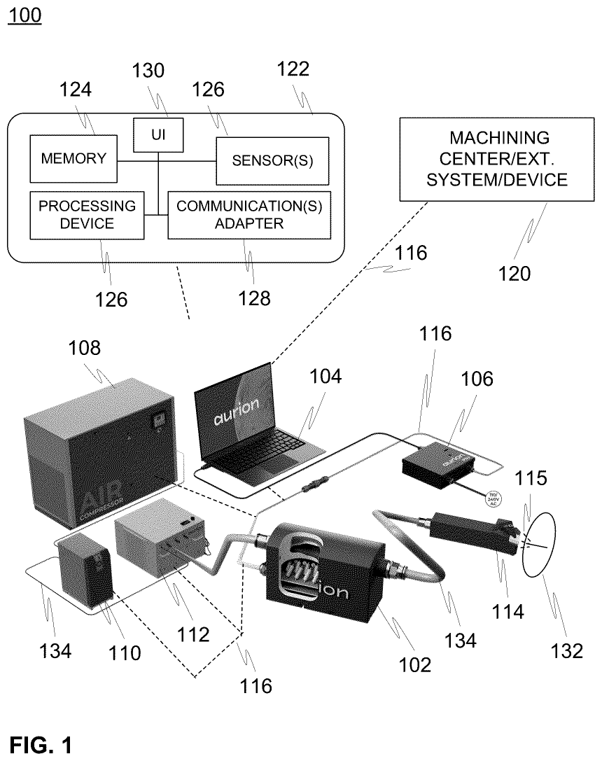

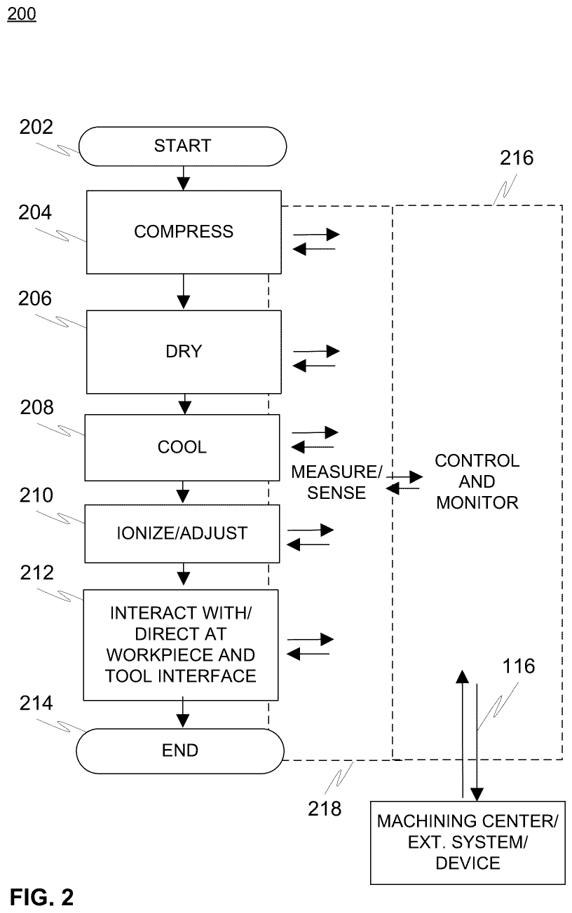

FIG. 1 represents, at 100 via a system level block diagram, an embodiment of a system in accordance with the present invention and potential elements thereof, as well as connectivity aspects having regard to potential external devices and systems. FIG. 2 is a flow diagram of an embodiment of a corresponding method.

Item 122 characterizes, by way of non-limiting example only, possible internals of one or more elements of the system 100, such as of control and monitoring equipment 104.

Indeed, various if not most, or practically all, elements of the system presented herein such as the control and monitoring equipment 104 or a programmable module 102 may comprise both software (instructions and other data) and hardware. With some elements such as element 104, selected general purpose gear such as a general-purpose computer (e.g. laptop or desktop) or other more generic hardware may be utilized to establish at least part of the element, advantageously together with tailored software and potentially more tailored hardware.

The hardware used may generally comprise e.g., a processing device 126 for processing the instructions and data included in or utilized by the software, a memory 124 for storing the software and potentially other data such as sensing/sensor data acquired from hosted or connected sensor(s) or sensing arrangements 122, and a communications adapter (such as a port or e.g., adapter for wireless communication) 128 for mutual communication and/or for communication with further devices and systems 120, for reporting, monitoring, control input, etc. purposes. Yet, a user interface (UI) 130 with a number of output (visual such as a display or a number of status lights such as LEDs, haptic, sound, etc.) and input (touch-based such as buttons, switches, a keyboard, a mouse, a touch surface or a touchscreen, (touchless) gesture, voice or generally sound, etc.) features may be included.

An element such as the control and monitoring equipment 104 may, from the implementation and technical realization point of view, refer to a centralized or separate element, or be implemented as distributed e.g., in a plurality of modules optionally integral with a number of other elements of the system, as being appreciated by a person skilled in the art.

The dynamic control system 100 for obtaining optimal gaseous flux in machining workpiece material in accordance with various embodiments of the present invention may comprise a number of elements such as a programmable (main) module 102 optionally supporting e.g., pulse width modulation (PWM) or other type control (signal) for internals such as an electric field chamber, e.g. corona chamber with electric field and related control and monitoring equipment 104 at least functionally connected therewith via wired or wireless communication link(s) or channel(s) discussed in more detail hereinafter, wherein different process parameters of e.g., quantitative or qualitative nature may be measured, controlled, optimized and stabilized, such as loop current of corona, polarity control, temperatures, and/or dew point of gaseous flux (inlet/outlet), pressure including ion content (anions and cations) on gaseous flux and mixing additional additives on the flux. This provides for gaseous flux parameters remarkable real-time control and stabilization options.

The dynamic control system 100 incorporating the control and monitoring equipment 104 can advantageously also utilize available online or offline data received or generally obtained from a number of sources such as machining and tool monitoring features (integral with tool 114 or separate therefrom), such as cutting force, torque, high-frequency displacement or acceleration of a tool or workpiece, laser interferometer data (e.g. on spindle shafts), acoustic emission (AE) data of machining, temperature data, surface quality inspection data by laser or camera inspection (imaging), which may be together harnessed to establish the most accurate gaseous flux control and optimization scheme available for machining workpiece material. The acquired data enables more advanced real-time control and stabilization for gaseous flux parameters.

Above discussed measurements and monitoring activities may be configured to involve even more detailed and advanced data gathering and analysis from the process environment. One major aspect is to realize the criteria set by and preferences associated with each particular use environment and use scenario for the whole process. Thus, several environmental parameters can be implemented and integrated in the system 100 by metrology and meteorology sensors, for instance.

In various embodiments, the dynamic control system 100 is typically provided with one or more of the following elements (can be separate but functionally connected devices (modules, units, etc.) or integral, e.g., having a common housing, with at least one other element, as alluded to hereinbefore);
compressor device or system 108 (e.g., compressed air or other gas/gaseous fluid network system) producing compressed gaseous flow, from input source fluid;
filter or (membrane) dryer 110 for dehumidifying gaseous flow, such as compressed air flow, preferably positioned upstream from any cooling unit;
cooling unit 112 for continuous gaseous flow preferably positioned downstream from the dryer 110 to reduce the temperature of gaseous fluid;
programmable module 102 with e.g., pulse width modulation type control scheme and electric field chamber;
power supply unit 106 (PSU) for the module 102, preferably incorporating a number or plurality of data-converter(s) such as AD (analog->digital) converters (the unit 106 and/or the converter(s) could also be at least partially integral with other elements, such as any of elements 102 and/or 104);
control and monitoring equipment 104 with associated software and necessary communication interface(s) (e.g. wireless or wired communication adapters for establishing related communication links) for controlling the module 104 and optionally further elements of the system 100 (e.g., compressor 108, dryer 110, PSU 106, and/or cooler 112);

communication and/or storage features (e.g., wired or wireless data transfer features such as channels or links, related adapters and interfaces, wiring, network and/or network gear) 116 for internal (between system elements) and external communication such as communication with machining center or various external devices or systems 120, (additional) sensors (e.g., ion measurement, dew point).

Compressed gaseous flow may refer to clean compressed air, for example, which may be provided by a separate compressor or a network compressor 108 as contemplated also herein elsewhere. Additionally or alternatively, other type of gas can be utilized, such as nitrogen or argon, potentially having extra features for the machining process.

Typically compressed air is commonly available. However, compressed air often also has high humidity level with water drops, which can cause serious issues when subjecting the air flow to cooling, especially when operating under 0° C. Thus, an external or integrated filter or e.g., membrane type or other type of a dryer is advantageously applied to dry the compressed air and preferably achieve a lower dew point than the operating temperature of air/gaseous flux. This unit 108 and associated process is considered particularly useful upstream from a cooling unit 112, because high humidity easily causes subsequent system element(s) (e.g., cooling unit and programmable module) to freeze and malfunction.

The cooling unit 108 produces the continuous cooled air/gaseous flow to the programmable module: This unit may have inlet for compressor (network) pressure and outlet with pressure control e.g., between 0.2 bar and 8 bar. Operating temperature arranged is typically between +15° C. and −30° C., e.g. about −10° ° C. Cooling may be implemented with cold air guns (Vortex), but conventional cooling method based on e.g., the use of a compressor actually appears to be more efficient and preferred in many applications; compressed air is also expensive/limited resource and cooling unit 108 can be additionally utilized to control the air flow and minimize the final air consumption.

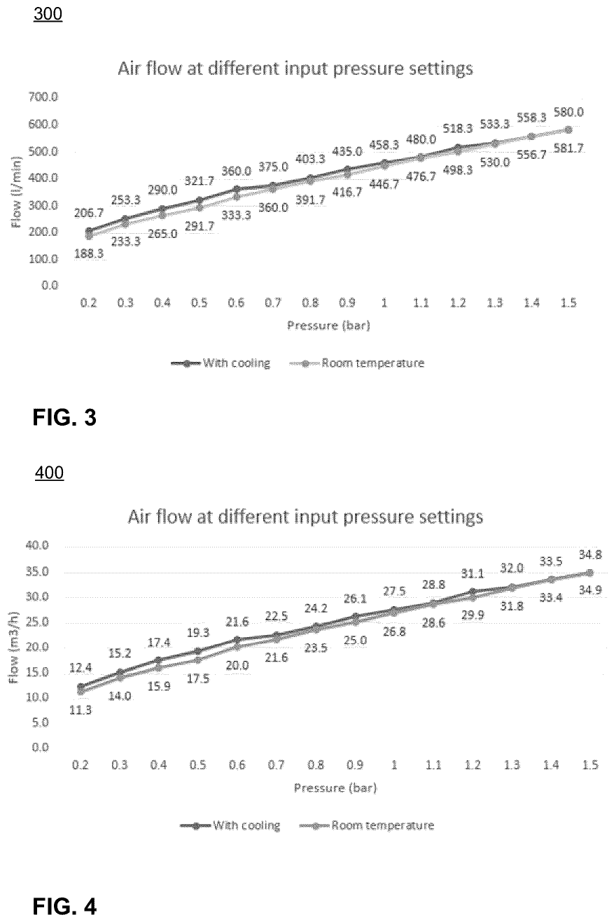

FIGS. 3 and 4 represent measurement data (air flow curves) about the use of compressed air vs cooled air at 300 and 400. As can be understood based on the concerned FIGS., air flow utilization is around 100% and thus efficiency very high (low loss) with compressor cooling when comparing air flow in the air. Accordingly, the efficiency is clearly much higher than what e.g., a vortex tube—based solution can provide, wherein about 50% or more of the air flow is typically lost.

Programmable module 102 is a preferably real-time programmable (meaning at least dynamically controllable and/or configurable if not hosting necessary features such as processing device, memory, and/or computer software or computer program per se) by integral and/or functionally connected control and monitoring equipment 104 (and/or by machine center or various external remote devices or systems 120 that may be at least functionally connected to the module 102, optionally via the equipment 104) and optionally capable of also autonomous action, having the necessary control data internally stored thereat. The module 102 may generate an internal control signal or at least apply (external) control signal such as a pulse width modulation (PWM) signal (that enables e.g., uA level control resolution with ease), which in turn drives internal components such as a transformer/voltage multiplier block and results in a high voltage (HV) between 7 kV-12 kV (HV), wherein the adjustment is controlled e.g., by the pulse ratio of the PWM signal.

The negative/positive pole of HV voltage is connected to a needle and the positive/negative pole is connected to a cylinder, depending on the target polarity. These connections generate an electric field, which is determined by current between the needle and cylinder in the corona chamber, and the loop current is formed through a cascade, which consequently determine the density of the ionized gaseous flux subsequently output at 115 towards the interface between the tool 114 and workpiece 132.

Strength of the electric current depends on the level of the control signal, such as aforesaid PWM signal, which is typically between about 150 uA-200 uA. The loop current may be measured by the AD-converter and processed with the specific control and monitoring equipment and software in or at least functionally connected to the module. In automatic mode the output current value is fixed or set with software programmed PWM value, for instance, and dynamic environmental changes and variations may be taken into account in the process by the necessary adjustments to stabilize and optimize associated parameters.

The module 102 may comprise at least one sensor(s) for output flux temperature, flow rate or ratio (e.g., per unit area), and/or ionization level, for instance. The electric field (corona) chamber may comprise a UV imaging or other sensor for corona activity, for instance, and/or e.g., a polarity or other detector (sensor) for the flux.

Also the tool 114 or tool 114—workpiece 132 interface may be provided with a number of sensors for e.g. machining force and/or acoustic emissions among other options for gathering the sensing data utilized in the feedback, analysis and adaptation loop of the present solution for (re-)adjusting the flux characteristics and adapting the system accordingly. Acoustic or audio sensor may be utilized to capture e.g., the noise created by the machining tool 114 and/or other elements involved in the process, which may indicate and be therefore utilized to estimate e.g., tool wear (increased noise, for example, or changed spectral content of the captured audio working as indicators). Accordingly, flux characteristics may be adapted and e.g., ionization level and/or flux rate increased in the aforementioned example. Yet, a camera/imaging sensor may be included for visual monitoring and analysis.

Temperatures may be measured utilizing e.g., NTC (negative temperature coefficient) principle by a number of resistor (thermistor) elements whose resistance varies according to temperature. A resistance/voltage conversion can be made and measured by the AD-converter and processed with the specific control and monitoring equipment and/or software.

The module 102 may have an integral user interface (UI) such as a plurality of LED diodes: e.g., first/red indicative of whether a communications interface/link such as a serial interface, e.g. RS485/USB, works properly and second/green indicative of whether the defined output current in electric field has been reached. Additionally or alternatively, similar or different UI features may be utilized in other elements, such as PSU 106, equipment 104, or further elements.

The module 102 may have or be connected to e.g., a serial interface type adapter (e.g., RS485) for connectivity and communication purposes. Control and monitoring equipment such as a computer or other similar equipment 104 can be then connected to the module 102 with a USB (Universal Serial Bus) to RS485 adapter (converter) or other compatible adapter, for instance. Specific control software preferably allows to program the required parameters for the module 102, wherein e.g., 8-bit microprocessor, microcontroller or other computing device handles computer and module (serial interface) traffic, such as PWM value for the output current, the measurement period etc.

Power supply unit (PSU) 106, optionally hosting at least part of the aforesaid adapter, advantageously operates at 110/240 VAC with output voltage 15 VDC, which may provide the necessary power supply including operating voltage to the module 102. The PSU voltage may be measured by the AD-converter and processed with the specific control and monitoring equipment or associated software.

The control and monitoring equipment 104 incl. software preferably has a plurality of dynamic control, monitoring, programming and communication features advantageously with automatic and manual options, with reference to related contemplations above. The equipment/software allows to adjust process control parameters during machining either manually or by automatic adaptation. It also advantageously has a reporting interface or feature, wherein operational module data can be read in real-time and presented e.g., on a graphic display, having regard to parameters or sensor output such as output current, airflow or flux temperature as a function of time, etc. Also, data storage is possible for further analysis and control.

The control logic embodied in the control software may, for example, control the aforementioned control signal such as PWM signal of the module 102 by adjusting the associated pulse ratio (high/low or on/off ratio) that causes a predetermined response in the module 102 (e.g., adjustment of operational parameters affecting e.g. the electric field chamber and subsequently the configuration of the produced ionized gaseous flux) and/or gaseous flow rate per unit area in order to compensate e.g., tool wear, minimizing acoustic emission noise, decrease the machining forces. For example, ion content and charge of the flux, for example, can be measured and controlled offline or online, as well as air dew point, cooling temperature, environmental parameters, etc. This control equipment and software is not limited above mentioned features, operations and communication options. There can be e.g., a remote control method/system/device and global data storage and sourcing system involved, etc. The equipment 104 may have at least partial control over a plurality of elements (106, 108, 110, 112, and/or 114) of the system 100 and optionally further element(s) in addition to the module 102.

Accordingly, wireless or wired communication channels or links 116 may be established between the control and monitoring equipment 104 and further element(s) of the system 100 or with additional devices or systems 120 such as a machining center, whereto active machining process data and signals, such as machining forces and temperatures, tool wear and surface quality could be provided for analysis, potential resulting control actions for the optimization of gaseous flux parameters, for instance, and data storage among other potential uses. The associated connections may be e.g., TCP/IP (Transmission Control Protocol/Internet Protocol) or the Internet based. Generally, the system 100 may be configured to apply a number of communication methods (medium, protocol, etc.) for providing internal or external communication, and thereby host the necessary adapters and possible other features such as intermediate wiring/cabling or other required equipment for the same.

The system 100 may thus communicate with various types of e.g. machining center, machine controller, machine tool control system etc. In some embodiments the system 100 can utilize Meter-bus (M-Bus) or Bus interface by wired or wireless communication in at least a portion of the communication links or channels 116. The M-Bus standard is developed for remote reading of water, gas or electricity meters. M-Bus may yet also be utilized in the context of the present invention in connection with any data and signals, e.g. transfer of sensing data. M-bus may thus be employed in controlling of machining equipment such as tool 114 or components thereof. One or more controlled entities may utilize G-code protocol, while the system 100 can utilize G-code and/or M-code protocol in the same M-bus interface.

Gaseous flow/flux may be transported through the system 100 and elements thereof using appropriate piping or hosing 134, for example.

FIG. 2 shows a flow chart of a method according to one exemplary embodiment of the invention. After a start 202 of the method, a gas or gaseous fluid may be compressed 204 to provide a compressed gaseous flow. At 206, the compressed gaseous flow may be dried to dehumidify the compressed gaseous flow. The method may then comprise cooling 208 the compressed gaseous flow to reduce the temperature of the gaseous flow.

The gaseous flow may be ionized 210 and preferably adjusted and then the gaseous flow may be directed 212 at a workpiece and tool interface or allowed to interact with the workpiece and tool interface. At 214, the method is ended.

The method comprises, optionally essentially continuously or at least simultaneously to at least some of the previously disclosed method steps, obtaining 218 sensing data comprising e.g. data indicative of machining force, temperature, tool wear and/or surface quality, and/or acoustic emissions. Based on the sensing data, a number of flux characteristics relating to characteristics of the gaseous flow are adjusted 216 (and/or measured or estimated), preferably essentially continuously, so as to provide or control, optionally stabilize, a number of reactions advantageously including electrochemical reactions in the machining area whereto the flux is directed 212, optionally including comprising neutralization of workpiece and machining tool electric charges, oxidation of workpiece or workpiece and tool interface, and/or reducing temperature at workpiece and tool surfaces and associated interface. Control and monitoring equipment may communicate with an external entity such as external monitoring or control system or device or machining center, through communication links 116, whereby the control and monitoring equipment may utilize the obtained sensing/measured data that in providing the adjusting.

“A number of” refers herein to any positive integer starting from one (1), e.g., one, two, or three.

“A plurality of” refers herein to any positive integer starting from two (2), e.g., two, three, or four.

1. A control system of gaseous flux for machining material of a workpiece in a machining area e.g., on a machining table, wherein the contacting materials of the workpiece and machining tool are preferably mutually different and electrically charging and/or electrically conductive such as metals or other materials of that nature, the system comprising:
a module comprising an electric field chamber for producing and outputting ionized gaseous flux from input, preferably continuous, gaseous flow; and
control and monitoring equipment at least functionally connected with the module,
wherein the control and monitoring equipment is configured to dynamically, optionally substantially continuously, estimate, measure and/or adjust, based on input sensing data, a number of flux characteristics including flow rate, polarity and/or ionization level, such as density of ionization, so as to provide and/or control, optionally stabilize, a number of reactions advantageously comprising electrochemical reactions in the machining area, optionally comprising neutralization of workpiece and machining tool electric charges, oxidation of workpiece or workpiece and tool interface, and/or reducing temperature at workpiece and tool surfaces and associated interface.

2. The system of claim 1, configured to utilize data about optionally at least quasi-constant basic parameters or characteristics of a concerned use scenario, optionally indicated by the sensing data and/or including preset or user-selected data, in determining the adjustment of the number of flux characteristics, wherein the parameters or characteristics comprise or are based on at least one element selected from the group consisting of: material of the machining tool, material of the workpiece, machining technology utilized, gas or gaseous fluid utilized, tool type and dimensions, and workpiece dimensions.

3. The system of claim 1, wherein the sensing data utilized in determining the adjustment indicate or are processed or otherwise utilized to indicate current and/or past characteristics of the input gaseous flow, such as pressure, temperature or dew point, one or more of the characteristics of the output ionized gaseous flux, properties or conditions at the interface between the workpiece and the machining tool, property or condition of the machining tool such as dimensions and/or wear, and/or property or condition of the workpiece.

4. The system of claim 1, wherein the adjustment is based on a difference between a selected desired output ionized gaseous flux determined through utilization of the sensing data and optionally further data such as data indicative of preset or user-selected use scenario characteristics, and current output ionized gaseous flux optionally determined based on current control parameters of the system or one or more elements of the system, e.g. programmable module, control and monitoring equipment, etc., and/or sensing data, further wherein the difference is to be minimized by the dynamic adjustment of the number of flux characteristics.

5. The system claim 1, comprising a filter or membrane dryer for the gaseous flow, such as compressed air flow, preferably positioned upstream from an optional cooling unit and/or downstream from an optional compressor, to achieve a low dew point for the gaseous flow, preferably lower than the temperature of gaseous flow.

6. The system of claim 1, comprising a cooling unit for the gaseous flow, preferably positioned upstream from the module and/or downstream from the optional dryer, configured to produce temperature falling within a range between about +15° ° C. and about −30° C. for the gaseous flow.

7. The system of claim 1, configured to optimize, preferably minimize, gaseous flow rate, optionally at the module, cooling unit, and/or other element of the system, to spare energy and/or the gaseous fluid used for establishing the gaseous flow and subsequent ionized gaseous flux.

8. The system of claim 1, comprising at least one element selected from the group consisting of:
power supply unit preferably with a number of AD conversion channels, positioned between the programmable module and control and monitoring equipment or at least partially integrated with either;
a number of wired and/or wireless communications links optionally in the form of a network or communication bus, between the control and monitoring equipment and the programmable module, other element of the system, and/or external monitoring or control system or device, wherein data transferred preferably include sensing data such as data indicative of machining force, temperature, tool wear and/or surface quality, said data optionally utilized for optimizing the flux characteristics during adjustment thereof, wherein the communication bus optionally comprises Meter-Bus; and
processing device such as a microprocessor, a digital signal processor, ASIC (application specific integrated circuit), or a microcontroller, for processing data such as instructions and other data such as sensing data, memory for storing data, and a communications adapter such as a wired or wireless network adapter or serial interface adapter for exchanging data.

9. The system of claim 1, configured to provide negative polarity, positive polarity, or bi-polarity in the electric field chamber to perform the adjustment.

10. The system of claim 1, configured to provide and adjust ion content, total charge, and/or polarity for the ionized gaseous flux.

11. The system of claim 1, configured to adjust flow rate per unit area preferably to reduce tool wear, acoustic emission noise and/or machining forces.

12. The system of claim 1, configured to adjust pneumatic air flow control.

13. A method for controlling the provision of gaseous flux in machining workpiece material, wherein the workpiece and machining tool materials are preferably mutually different and electrically charging and/or conductive such as metals, comprising:
producing and outputting ionized gaseous flux based on, preferably continuous, gaseous flow of gaseous fluid through utilization of a programmable module comprising an electric field chamber,
wherein a number of flux characteristics comprising flow rate, polarity and/or ionization level, such as density of ionization, are dynamically, optionally substantially continuously, measured, estimated and/or adjusted, based on input sensing data, so as to provide or control, optionally stabilize, a number of reactions advantageously including electrochemical reactions in the machining area whereto the flux is directed, optionally comprising neutralization of workpiece and machining tool electric charges, oxidation of workpiece or workpiece and tool interface, and/or reducing temperature at workpiece and tool surfaces and associated interface.
